(19) United States
(12) Patent Application Publication
(10) Pub. No.: US 2018/0347764 A1
(43) Pub. Date: Dec. 6, 2018

(54) System and Method for Detecting Broken or Clogged Drainage Pipe Structures

(71) Applicant: James M. Kellar, Jonesboro, GA (US)

(72) Inventor: James M. Kellar, Jonesboro, GA (US)

(21) Appl. No.: 16/001,850

(22) Filed: Jun. 6, 2018

Related U.S. Application Data
(60) Provisional application No. 62/515,620, filed on Jun. 6, 2017.

(51) Int. Cl. F17D 5/06; G01M 3/18

(52) U.S. Cl. CPC F17D 5/06; G01M 3/18

(57) ABSTRACT

This system and method performs an acoustic scan of a non-pressurized pipe structure typical of septic and sewer systems to detect clogs, line breaks and any structural change in construction. An acoustic scan of the pipe structure is performed periodically by injecting a frequency band limited reference signal into the pipe structure. The pipe structure responds by modulating the reference signal and is representative of the pipe structure's physical construction. The system uses this modulated response to detect variations in the construction of the pipe structure by comparing against a known good calibration standard collected prior. An error score is generated based on the amount of variation from the calibration standard and is compared against a threshold to trigger an alarm condition. If the threshold is exceeded, indicating that a piping issue exists, an alarm is initiated so a user can take appropriate actions to resolve the condition well before a backup or flood begins to occur.

### BACKGROUND OF THE INVENTION

### References

U.S. Pat. No. 9,920,511—Methods, systems and software for providing a blocked sewer alert

U.S. Pat. No. 9,123,230—Sewer backup alarm

U.S. Pat. No. 7,907,059—Sewage pipe alarm system and associated method

U.S. Pat. No. 7,821,411—Safety device for monitoring a conduit

U.S. Pat. No. 5,699,049—Monitoring system for non-pressurized conduit

U.S. Pat. No. 5,687,761—Sewer backup indicator apparatus

U.S. Pat. No. 4,973,950—Sewer blockage alarming

2007/0063856—Monitoring system for drain pipes and plumbing fixtures

### FIELD OF THE INVENTION

The invention relates generally to a detection system for non-pressurized drainage pipe structures. Specifically the invention relates to a detection system that is mounted into a non-pressurized pipe structure and which monitors said pipe structure's physical construction and characteristics such that if any modification of said structure occurred, for example re-plumbing, blockage or broken pipe, the system would detect this change and generate a visual and/or audible warning prior to any negative or damaging effects caused by the modification such as flooding or fluid backup.

### RELATED ART

Drainage systems are implemented everywhere from homes to businesses. Eventually all drainage pipe structures experience becoming clogged or broken through any variety of means causing them to fail at their intended purpose. In most instances this is only discovered when it is too late and damage has already occurred due to fluids and waste materials draining in unintended locations or backing up into bathtubs, sinks, and other fixtures. When this happens professionals are typically needed to repair or replace the damaged property and can easily become very expensive. In many cases, as in septic or sewage systems, the fluids and materials to be drained can be hazardous and a backup or flood at the source is potentially dangerous, for example raw sewage.

Detection mechanisms do exist to detect blockages but seem to be rarely seen in commercial and consumer applications and those that are are deficient in detection because the detection methods used measure the result of a clog such as water level rise, flooding and backups rather than monitoring the pipe structure itself. Systems detecting broken or leaking pipe structures exist as well but are large and expensive and typically used in industrial applications so are rarely available for commercial or consumer monitoring. Existing clog solutions typically use floats, pressure or capacitance for detection to trigger alarms when fluids to be drained backup enough to alter a trigger device's physical position or response. These solutions are very straightforward however many implement moving parts which inherently tend to fail due to age, potentially experience build-up and are affected by any variety of mechanical issue. Solid state solutions solve the potential for mechanical failure however still detect an issue, usually only a clog, once fluids have built up to a catastrophic level of failure.

It will become apparent in the invention's description herein how it realizes significant improvements over prior art devices. It is capable of detecting damage to non-pressurized pipe structures whether blocked or broken without the requirement of experiencing unfortunate results such as flooding or backups.

### BRIEF SUMMARY OF THE INVENTION

The invention comprises a method and apparatus for detecting alterations within non-pressurized pipe structures from their original construction which would cause the structure to fail by clogging or draining inappropriately providing protection against damage from backups and flooding before they occur. The invention employs means to generate a reference signal which is injected into and modulated by said pipe structure. The modulated reference feedback signal contains information corresponding to said pipe structure's physical construction through resonant response characteristics. The invention demodulates said modulated signal feedback and collects a plurality of said resonant characteristics, referred to as profiles, and periodically compares against a reference profile, called a calibration profile, in order to detect physical changes in a pipe structure's constructed state.

The invention employs processes to extract and analyze in detail said piped structure's resonant profile collected by a sensing transducer. Said processes are comprised of a plurality of mathematical operations used together bringing forth the information contained within the modulated reference signal and comparing this information against prior information collected from a known good constructed state.

The invention is electrically powered and allows for implementation as a low power solution and may use but not be limited to the use of batteries as a power source avoiding complicated wiring requirements making it simple to implement and install into existing pipe structures such as septic or sewer systems using standard materials. The invention also allows for implementation as described herein mounted in or onto a housing attaching to standard sized pipe access port caps typical within the field of the invention.

The invention allows for a variety of interface and alarming methods including the use of a wireless transceiver that may be employed to provide communications for remote visual and/or audible alarms, monitoring and calibration. Additionally light emitting diodes (LEDs) and buttons may be employed for direct interaction with the invention providing visual and/or audible alarming, monitoring and calibration.

### BRIEF DESCRIPTION OF THE DRAWINGS

FIG. 1 Illustrates one embodiment of the invention revealing an exploded model view of the present implementation.

FIG. 2 Illustrates how the assembly in FIG. 1 mounts into an existing pipe structure mounted to a standard pipe cap.

FIG. 3 Illustrates a block diagram of the electrical system.

FIG. 4 Illustrates a flow diagram of how the reference signal is generated.

FIG. 5 Illustrates a flow diagram of the feedback signal processing chain.

FIG. 6 Illustrates a typical profile measurement.

FIG. 7 Illustrates an error profile result between a calibration profile and a normal cleared pipe structure profile.

FIG. 8 Illustrates an error profile result between a calibration profile and a clogged pipe structure.

REFERENCE NUMERALS IN THE ILLUSTRATIONS

| | | | |
|---|---|---|---|
| 100 | Standard Pipe Cap | 110 | Housing |
| 120 | Housing Ring | 130 | Printed Circuit Board |
| 140 | Battery | 150 | Speaker |
| 200 | Clog Detector Assembly | 210 | Septic/Sewer Drainage Pipe |
| 300 | Microphone | 310 | Amplifier |
| 320 | Low Pass Filter | 330 | Microcontroller |
| 340 | Low Pass Filter | 350 | Amplifier/Driver |
| 360 | Speaker | 370 | Light Emitting Diode Indicator |
| 380 | RF Transceiver | 390 | Button |
| 392 | Battery Source | 395 | DC-DC Voltage Regulator |
| 400 | Variable Frequency Clock Source | 410 | Digital to Analog Converter |
| 420 | Storage Table (Memory) | 430 | Low Pass Filter |
| 440 | Timer | 450 | Storage Table (Memory) |
| 460 | Amplifier/Driver | 470 | Speaker |
| 500 | Analog to Digital Converter | 510 | Decimation Block |
| 520 | Rectifier Block | 530 | Low Pass Filter |
| 540 | Decimation Block | 550 | Storage Memory-New Sampled |
| | | | Profile |
| 560 | Storage Memory-Calibration | 570 | Subtraction Block |
| | Profile | | |
| 580 | Storage Memory-Error Profile | 590 | Rectifier Block |
| | Result | | |
| 600 | Summer Block | 610 | Comparison Block |
| 620 | Maximum Error Threshold Value | 630 | Routing switch |
| 640 | Routing switch | | |

### DETAILED DESCRIPTION OF THE INVENTION

The invention described more fully herein may be embodied in many different forms and should not be construed as limited to the embodiments set forth herein; rather, this embodiment is provided so that this disclosure will satisfy legal requirements. It is understood that various omissions and substitutions of equivalents are contemplated as circumstances may suggest or render expedient, but these are intended to cover the application or implementation without departing from the spirit or scope of the claims of the present invention. Phraseology and terminology used to describe the invention herein is not to be misconstrued as limiting.

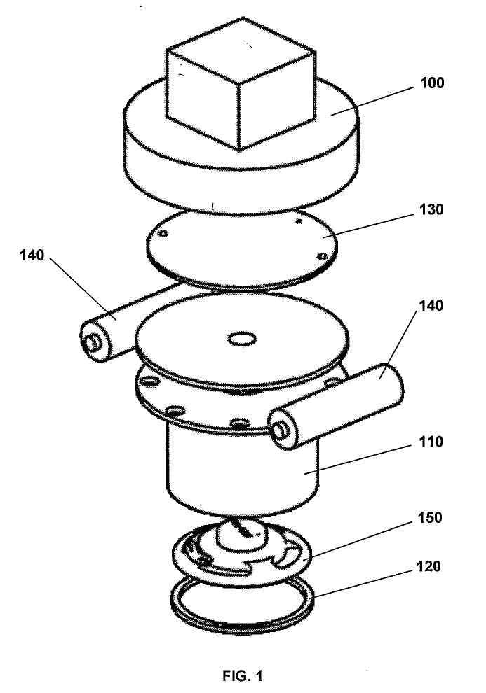

As shown in FIG. 1. the invention is housed such that it mounts onto a standard sized access port pipe cap, element 100, typical of the field used in septic and sewer drainage systems. A printed circuit board (PCB), element 130 and batteries, elements 140, are mounted toward the upper end of the housing and where the batteries reside in the area just below the PCB. A transducer (e.g. speaker), element 150, mounts into a chamber at the lower end of the housing for conversion of the reference signal from electrical form to acoustic waveform. A retaining ring, element 120, secures the transducer within the chamber and to the housing.

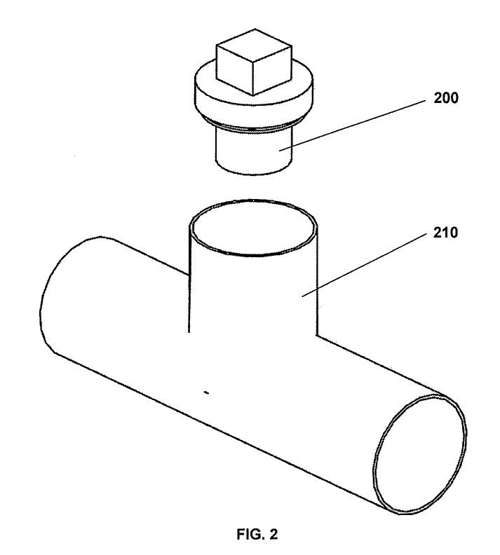

FIG. 2 illustrates how the invention's assembly, element 200, may be mounted into an access port location on a pipe structure, element 210, typical of these types of drainage systems.

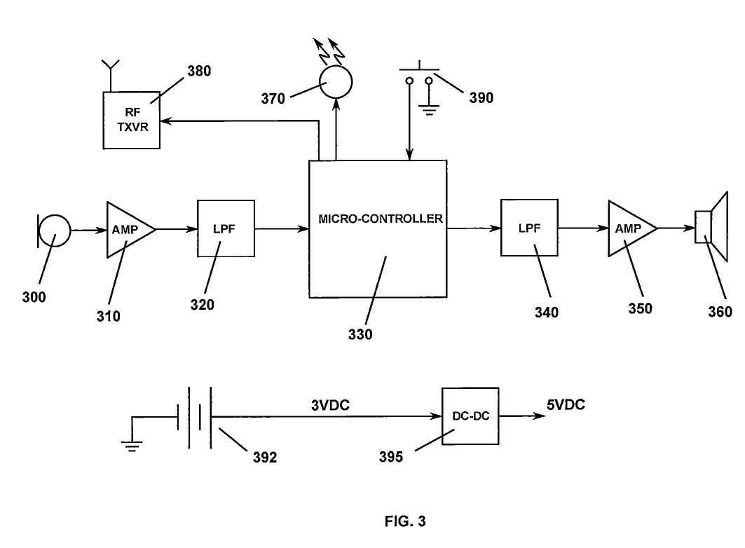

FIG. 3 illustrates one embodiment of the electrical system. The invention employs means of signal generation, detection, processing and alarming. Element 360 in this embodiment is implemented as a speaker and is used to inject an acoustic wave reference signal into the pipe structure containing a plurality of frequencies between 25 Hz to 300 Hz. As element 360 is injecting a reference signal element 300, implemented as a microphone in this embodiment, detects an acoustic feedback signal that is a modulated version of the reference signal created by the pipe structure in response to the aforementioned injected reference signal. This feedback signal contains a plurality of resonant points aligning with the plurality of frequencies injected by element 360. These resonant points are a pipe structure's signature and contain information relating to the pipe structure's present physical characteristics. Specifically the information contained relates to the pipe structure's various lengths, diameter, material and connections. Element 300 in this embodiment translates acoustic waveforms into an electrical signal referred to as the feedback signal where elements 310, 320 and 330 then process the feedback signal. Elements 310 and 320 amplify the incoming signal and low pass band limit the raw detected feedback signal to 500 Hz respectively where it may be sampled by the microcontroller, element 330. Element 330 extracts the information from the feedback signal and determines whether an alarm condition has been detected and outputs a response accordingly. Element 392 in this embodiment is a battery power source providing power to all blocks of the system. Element 395 in this embodiment, typically called a DC to DC converter, provides means to boost voltage from the battery source voltage level, aforementioned as element 392, up to a higher supply voltage for driving audio amplification and visual alarming. Element 390, a button in this embodiment, is used to provide direct user interface capability to reset the system or force a calibration operation. A radio frequency transceiver, element 380, is included in this embodiment providing a secondary interface for user control, monitoring and alarming. And element 370 is a light emitting diode (LED) which provides visual cues to a user local to the system for alarming and general status feedback.

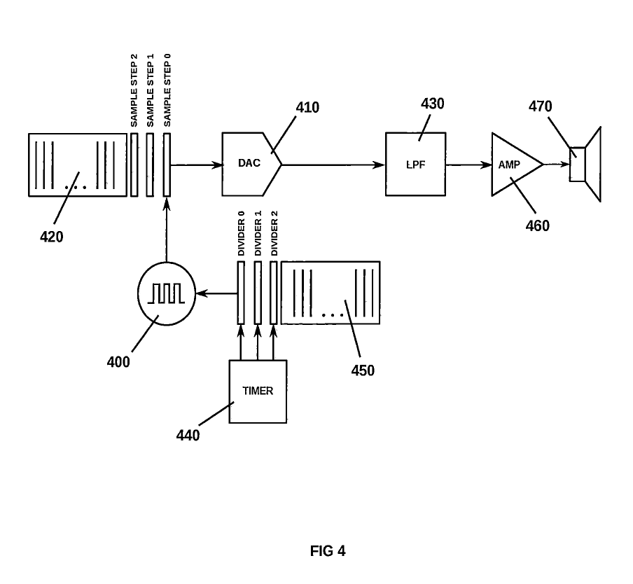

FIG. 4 diagrams how the reference signal in this embodiment is generated and injected into the pipe structure. Element 400 is a variable clock source which triggers values from element 420, a table of points along a sinusoidal waveform path, to feed element 410, a digital to analog converter (DAC) at a specific rate. As values from element 420 are fed to element 410 it outputs corresponding voltages based on the values applied from element 420 at a rate provided by element 400. As element 400 feeds table values into element 410 at varied rates a plurality of frequencies are generated. A timer, element 440, triggers an increase in the variable clock source's frequency by element 450, a divider table, every 345 ms thereby increasing the rate sinusoidal table values are fed to the DAC from element 420 at each 345 ms increment. This translates into an increasing frequency of the output sinusoidal waveform at each said increment. The process continues for 10 seconds generating a sweep of frequencies between 25 Hz to 300 Hz. Element 430, a low pass filter, provides high frequency filtering from the DAC output maintaining only the 25 Hz to 300 Hz frequencies. Element 460, an amplifier/driver, is fed by the low pass filter and drives element 470, a speaker, which converts the electrical signal into air pressure, i.e. sound, directly injecting an acoustic waveform into said pipe structure.

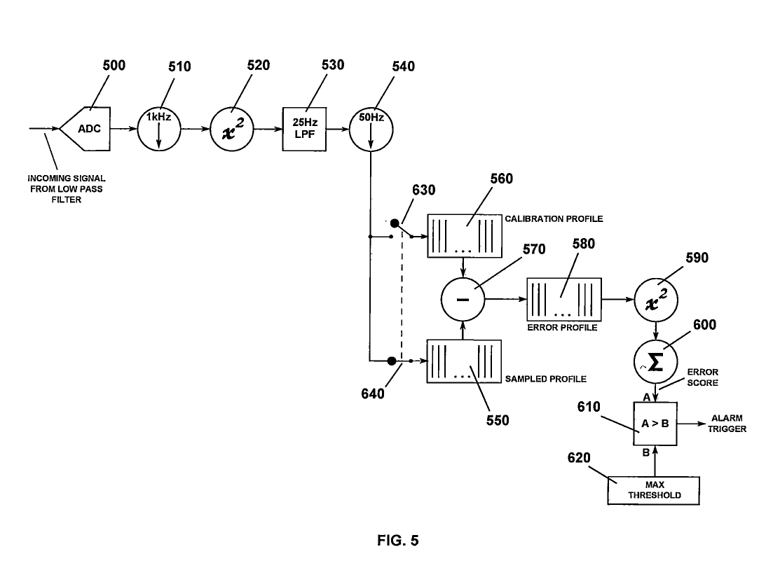

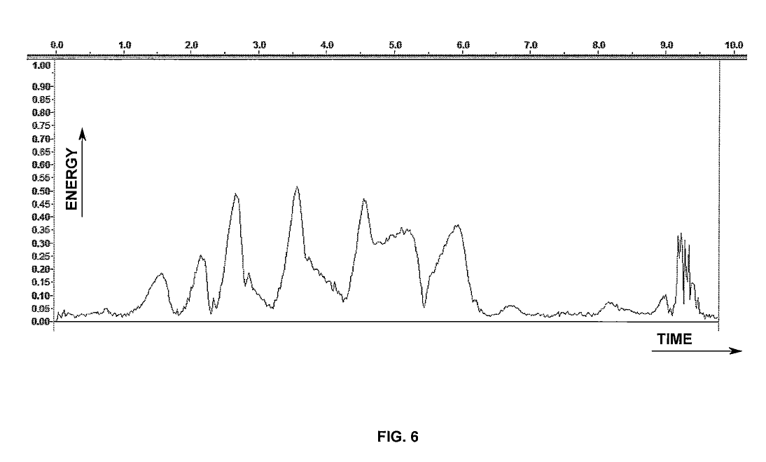

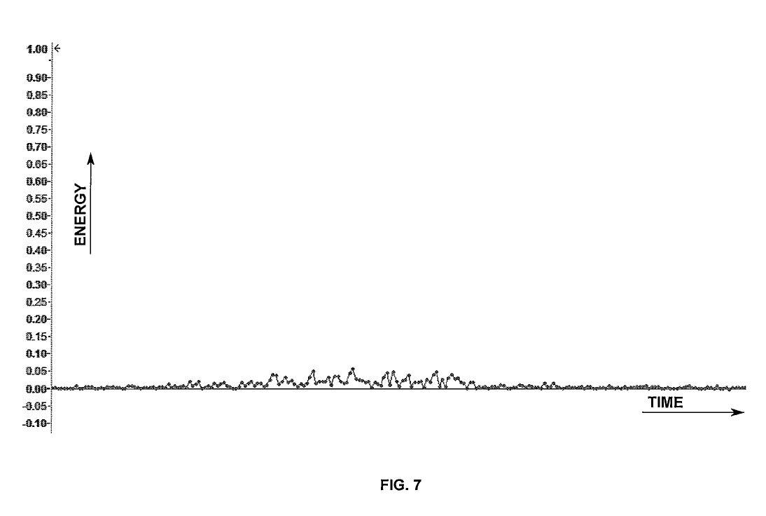

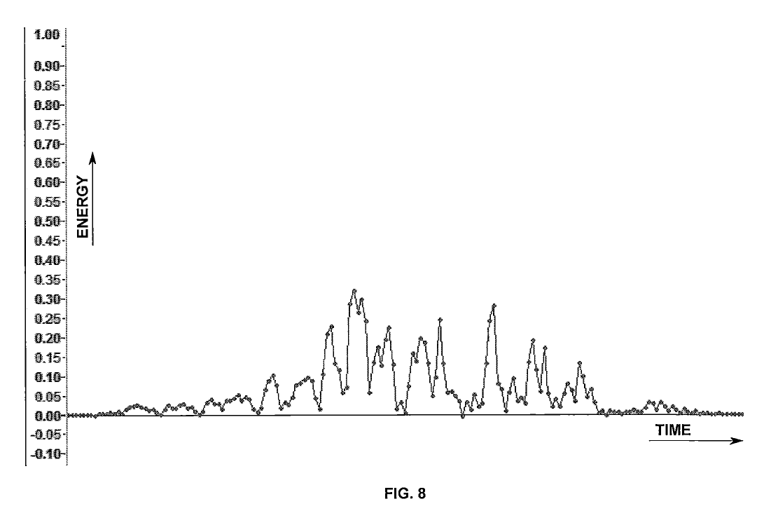

In FIG. 5 the signal processing flow diagram shows the process used to capture and analyze the aforementioned modulated feedback signal. An analog-to-digital converter (ADC), element 500, samples the incoming feedback signal in this embodiment at 100 kHz, a high speed rate relative to the frequency band of interest. Extracted from the ADC samples by element 510 are only those samples occurring every 1 ms, or at a 1 kHz rate, the Nyquist sample rate of the low pass filter referred to in FIG. 3 as element 320. This effectively decimates samples to the lower 1 kHz sample rate thereby reducing the incoming data rate while retaining all detailed pipe structure information contained within the modulated feedback signal. The next stage of processing is to rectify, i.e. square, the sampled signal data with element 520 which extracts said information contained within the sampled signal representing the pipe structure's physical characteristics. Once the pipe structure information has been extracted element 530 further low pass band limits the signal to below 25 Hz stripping away the original reference signal frequencies. This result is then decimated further by element 540 to a 50 Hz sample rate reducing again the sample data size. At this 50 Hz sample rate a reference signal frequency sweep from 25 Hz to 300 Hz lasting for ten seconds will allow 500 sample points of the pipe structure's information to be collected and stored in element 550 representing said pipe structure's newly sampled profile or signature as shown in FIG. 6. A calibration profile, element 560, is simply a stored profile sample set collected from a known good pipe structure state prior to that of said newly sampled profile. Switch elements 630 and 640 determine to what storage location a profile is to be stored. The newly sampled profile stored in element 550 is then subtracted by element 570 sample point by sample point from element 560, the calibration profile. From element 570 an error profile result as shown in FIG. 7 is realized and stored in element 580. Said error profile result is then squared to remove all negative values by element 590 and all error profile sample points are summed using element 600 to complete the signal processing with a final error score result. The error score is a number representing the total energy of error between the sampled profile and the calibration profile. Element 610 compares against a predetermined maximum error score threshold, element 620, and a decision is made to alarm if exceeded. As shown in FIG. 7 a normal unblocked pipe structure error profile would not be cause for alarm however FIG. 8 shows how a blockage occurring only 4 feet in one leg of a 20 foot long pipe structure with two additional legs 5 feet long affects the error result profile. As shown in FIG. 8 the pipe structure with blockage has significantly more error energy and would trigger an alarm condition given a proper threshold limit, for example 5.0000 in this embodiment. The normal to calibration error score per FIG. 7 is 2.4988 whereas when a blockage is introduced the error score increases to 9.8364 per FIG. 8 thereby revealing an error in the pipe structure exists, a clog.

What is claimed is:

1. A system and method for detecting broken or clogged non-pressurized drainage pipe structures comprising: means to generate a frequency band limited plurality of electrical signals; a transducer used to inject said plurality of electrical signals into said pipe structure whereby said electrical signals are converted to acoustic waves; a transducer used to convert acoustic waves of modulated response signals from said pipe structure in response to said injected acoustic waves into electrical modulated response signals; a method of demodulating said pipe structure's modulated response signal whereby said injected electrical signals are removed leaving only said pipe structure's characteristic response signal; means to store a plurality of said pipe structure's characteristic response signals; a method of calculating a plurality of differences between said characteristic response signal and a prior sampled characteristic response signal generating a plurality of errors; a method of calculating the sum of said plurality of errors and comparing said sum against a defined threshold value representative of said pipe structure's maximum acceptable error variation from said prior characteristic response signal; means to indicate said maximum acceptable error variation has been exceeded whereby an alarm is generated; a housing whereby said transducers, supporting circuitry and power sources are mounted to said non-pressurized pipe structure through standard sewer and septic access ports.

2. The system and method of claim 1, whereby a variable frequency oscillator is used to generate a frequency band limited electrical signal.

3. The system and method of claim 1, whereby said pipe structure's characteristic response signal is extracted from said modulated response signal through a demodulation process comprising envelope detection.

4. The system and method of claim 1, whereby said plurality of errors is generated from the difference between said characteristic response signal and a stored prior characteristic response signal aligned in time.

5. The system and method of claim 1, whereby the sum of said plurality of errors is calculated by summing rectified values of each point within the plurality of errors.
